(19) United States
(12) Patent Application Publication
(10) Pub. No.: US 2008/0120124 A1
(43) Pub. Date: May 22, 2008

(54) Method of tracking changes of subscribers for an in-vehicle telematics service

(75) Inventors: Dennis Zoeckler, Brighton, MI (US); Nathan Ampunan, Novi, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/603,934

(22) Filed: Nov. 22, 2006

(51) Int. Cl. G06Q 99/00

(52) U.S. Cl. 705/1

(57) ABSTRACT

A method of tracking changes of subscribers for an in-vehicle telematics service includes periodically monitoring a service record database, which includes vehicle service information that is indicative of one or more vehicle service checks performed on one or more vehicles, and recognizing that a new vehicle service check is added to the vehicle service information based upon the periodic monitoring. The method also includes extracting vehicle identifying information, which is unique to a vehicle associated with the new vehicle service check, and inferring a subscriber status change for the vehicle responsive to the extracted vehicle identifying information. Further, the method includes setting a signal indicative of the inferred subscriber status change for the in-vehicle telematics service.

### TECHNICAL FIELD

The present disclosure relates generally to an in-vehicle telematics service, and more particularly to a method of tracking changes of subscribers for an in-vehicle telematics service.

### BACKGROUND

When a vehicle changes ownership, the telematics service provider for the prior owner may not become immediately aware of the ownership change. This may be due, at least in part, to the fact that vehicle owners often do not notify their telematics service provider that they are selling or returning their vehicle. As such, the telematics service provider generally relies on other strategies to acquire the updated ownership information. Alternatively, if the telematics service provider is notified of the change in ownership, there may be a time lag after notification and before subscriber databases at the telematics service provider are updated. When a telematics service provider does not have current vehicle ownership information, it may operate under the notion that a particular subscriber is active and has a functional telephone number, while, in fact, the wireless carrier has deactivated the particular vehicle number, and the new vehicle owner is unable to make or receive telephone calls.

As such, it would be desirable to provide an improved method for tracking changes of subscribers for an in-vehicle telematics service.

### SUMMARY

A method of tracking changes of subscribers for an in-vehicle telematics service includes periodically monitoring a service record database, which includes vehicle service information that is indicative of one or more vehicle service checks performed on one or more vehicles, and recognizing that a new vehicle service check is added to the vehicle service information based upon the periodic monitoring. The method also includes extracting vehicle identifying information, which is unique to a vehicle associated with the new vehicle service check, and inferring a subscriber status change for the vehicle responsive to the extracted vehicle identifying information. Further, the method includes setting a signal indicative of the inferred subscriber status change for the in-vehicle telematics service.

### BRIEF DESCRIPTION OF THE DRAWINGS

Features and advantages of embodiments of the present disclosure will become apparent by reference to the following detailed description and drawings, in which like reference numerals correspond to similar, though not necessarily identical components. For the sake of brevity, reference numerals or features having a previously described function may not necessarily be described in connection with other drawings in which they appear.

FIG. 1 is a schematic diagram depicting an embodiment of a system for tracking changes of subscribers for an in-vehicle telematics service;

FIG. 2 is a flow diagram depicting an embodiment of a method of tracking changes of subscribers for an in-vehicle telematics service; and

FIG. 3 is a flow diagram depicting an alternate embodiment of a method of tracking changes of subscribers for an in-vehicle telematics service.

### DETAILED DESCRIPTION

Embodiment(s) of the method and system(s) disclosed herein advantageously provide for improved tracking of subscriber changes for an in-vehicle telematics service. Telematics service providers (TSP), which offer various services (e.g., providing navigational instructions, weather and other information, keyless entry, emergency assistance, etc.) to its subscribers, may be inclined to keep track of subscriber information for one or more reasons. As non-limiting examples, the TSP may wish to contact a former subscriber to offer a subscription for his/her new vehicle, or to contact a new owner to offer a subscription for his/her new vehicle.

In an embodiment, databases including vehicle service information and telematics unit and/or subscriber information may be utilized (e.g., by the TSP) to determine that a failed attempt to connect the telematics unit to another party via a wireless carrier has occurred. From this failed attempt, the TSP may infer that a change in vehicle ownership has occurred.

It is to be understood that, as defined herein, a user may include vehicle operators and/or passengers, and may be used interchangeably with subscribers/service subscribers.

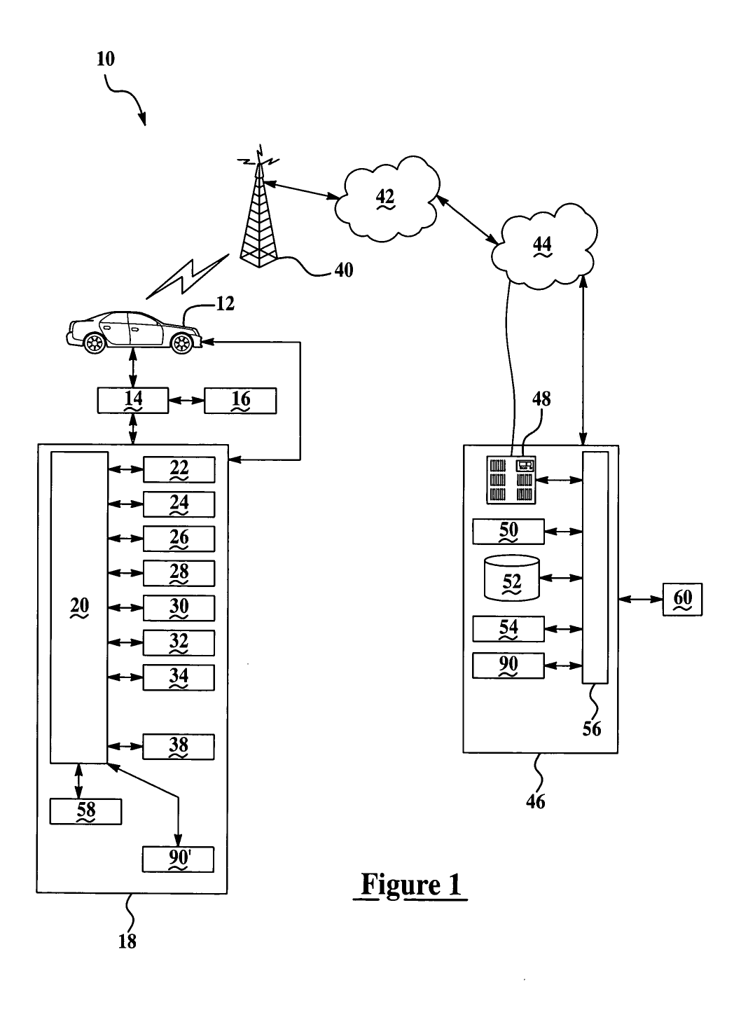

Referring now to FIG. 1, the system 10 includes a vehicle 12, a vehicle communications network 14, a telematics unit 18, a wireless communication system (including, but not limited to one or more wireless carrier systems 40, one or more communication networks 42, and/or one or more land networks 44). In an embodiment, the wireless communication system is a two-way radio frequency communication system. In another embodiment, the wireless communication system also includes one or more telematics service providers or call centers 46. It is to be understood that the terms telematics service providers and call centers are used interchangeably herein. In yet another embodiment, vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone 32, a real-time clock (RTC) 34, and/or a short-range wireless communication network 38 (e.g. a Bluetooth® unit).

It is to be understood that the telematics unit 18 may be implemented without one or more of the above listed components, such as, for example, speaker(s) 30. Yet further, it is to be understood that the speaker(s) 30 may be a component of the vehicle audio system (which includes a receiver), which may, in addition to radio broadcasts, accept audio and other signals from the telematics unit 18. Telematics unit 18 may include additional components and functionality as desired for a particular end use.

In an embodiment, when a user subscribes to wireless phone and/or internet services for a particular telematics unit 18, a wireless service provider (e.g., Verizon Wireless®, Cingular®, Sprint®, etc.) assigns a mobile number, which may include a mobile information number (MIN) and/or an mobile dialing number (MDN), to an electronic serial number (ESN). The ESN is unique to the in-vehicle telematics unit 18, and may be hard-coded in the telephone 32 associated with the in-vehicle telematics unit 18. The mobile number may then be associated with the subscriber's account record at the wireless service provider. It is to be understood that a unique station identification (STID) is also associated with the telematics unit 18, and is matched with or assigned to the vehicle identification number (VIN) of the vehicle 12 in which the particular telematics unit 18 is located.

In another embodiment, when a wireless service subscriber cancels the service, which may be incidental to selling or returning the vehicle upon expiration of a lease, the wireless service provider may dissociate the mobile number from the electronic serial number of the telematics unit 18 in the vehicle 12. It is to be understood that the wireless service provider may, in its discretion, reassign the mobile number to an ESN of another telematics unit 18 in another vehicle 12 after dissociating it from the first ESN.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown). In-vehicle mobile phone 32 may be a cellular type phone, such as, for example an analog, digital, dual-mode, dual-band, multi-mode and/or multi-band cellular phone.

Also associated with processor 20 is the previously mentioned real time clock (RTC) 34, which provides accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (i.e., call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46.

Call center or telematics service provider 46 may contain one or more data switches 48, one or more communication services managers 50, one or more communication services databases 52 containing subscriber profile records, event logs (e.g., service log) for the telematics unit 18, and/or subscriber information, one or more communication services advisors 54, and one or more network systems 56. As previously indicated, the call center/telematics service provider 46 assists the subscriber by offering various services, such as, for example, information lookup (e.g., restaurant information, weather information, news, etc.), navigational directions, audio/video service information, entertainment service information, directory information, keyless entry, emergency assistance, and/or the like, and/or combinations thereof.

It is to be understood that, although a wireless service provider may be located (or have agents located) at the telematics service provider/call center 46, the call center 46 is a separate and distinct entity from the wireless service provider. In an embodiment, the wireless service provider may interact with the call center 46 to provide a service to a user.

Switch 48 of call center 46 may connect to land network 44. Switch 48 may transmit voice or data transmissions from call center 46, and may receive voice or data transmissions from telematics unit 18 in vehicle 12 through wireless carrier system 40, communications network 42, and land network 44. Switch 48 may receive data transmissions from, or send data transmissions to, one or more communication service managers 50 via one or more network systems 56.

Call center 46 may contain one or more service advisors 54. In one embodiment, service advisor 54 may be human. In another embodiment, service advisor 54 may be an automaton.

As previously described, the communications services databases 52 may include records for each telematics service subscriber. These records may include personal information, telematics unit identifying information (i.e., ESN, MIN and/or STID), preference information, a log of any services that the subscriber has requested/received, a log of any maintenance or problems associated with the subscribers telematics unit 18, and/or other subscriber related information, and/or combinations thereof. As a non-limitative example, the telematics service subscriber record may include connectivity failure records. In an embodiment, the telematics service provider 46 attempts to call a vehicle 12 equipped with a telematics unit 18. If the call fails, the connectivity failure record associated with the telematics unit 18 is stored locally in the database 52. The association of the connectivity failure with the proper subscriber record is enabled by the STID, which is often used as a primary database key or index for the data stored in the communications services databases 52.

The call center 46 is also in communication with one or more service record databases 60, which store vehicle services information. It is to be understood that the vehicle services information is indicative of vehicle service checks performed on one or more vehicles 12. As an example, a vehicle service check may be performed when a vehicle 12 is traded in to a dealership, or is returned to a dealership upon expiration of a lease. In an embodiment, the vehicle service check is performed on every vehicle 12 received at the dealership, before the vehicle 12 is offered for sale and/or resale. The vehicle service check may include, for example, an engine check, an interior cleaning, an exterior cleaning, and/or the like.

It is to be understood that one or more dealership owners, managers, employees or the like has access to at least the service record databases 60 so that any information associated with the vehicle service check may be inputted. The dealership access may be limited to inputting and retrieving service record data. Non-limiting examples of such information include vehicle identifying information, the services offered and/or performed, payment information, and/or the like, and/or any combinations thereof.

The call center 46 periodically monitors the service record database 60. Periodic monitoring is to be interpreted broadly and may include, for example, monitoring at predetermined regular intervals, such as, for example, about every twenty-four (24) hours, or at irregular intervals, such as, for example, when a dealership informs the call center 46 that a service check has been performed. In another embodiment, monitoring occurs at off-peak times (e.g., when the call volume at the call center 46 is generally relatively low). It is to be understood that monitoring may also be staggered depending on the time zone in which the call center 46 and/or the dealership is located. As a non-limitative example of periodic regular monitoring, the service advisors 54 at the call center may check the service record database at the open or close of business each day. As such, periodic monitoring enables the call center 46 to recognize that a new vehicle service check has been added to the service record database 60.

After recognizing a new vehicle service check, the call center 46 extracts vehicle identifying information from the service record database 60. The vehicle identifying information is unique to the vehicle associated with the new vehicle service check, such as, for example, a vehicle identification number (VIN). It is to be understood that one VIN, or a list of VINs, may be extracted from the vehicle service checks. The number of VINs extracted depends, at least in part, on the number of vehicle checks added to the database 60 at the time of the extraction.

The call center 46 uses the vehicle identifying information to infer a subscriber status change for the vehicle 12. Such an inference is made in response to the extracted vehicle identification information. To make the inference, the call center 46 takes the vehicle identification number(s), and attempts to match the VIN with a STID stored in the subscriber records of the communications services database 52. As previously described, the STID may be used as a key to query the TSP (i.e., call center) subscriber records, which include TSP subscriber-specific identifying information and service event information. If an STID is found to match, or be assigned to, the VIN of interest, the vehicle 12 identified by the particular VIN contains a telematics unit 18. If an STID is not found to match, or be assigned to, a VIN of interest, it is an indication that the vehicle 12 associated with the VIN does not contain a telematics unit 18.

Once the call center 46 matches the VIN of interest with its STID, the call center 46 uses the STID to further search the subscriber records. In an embodiment, the further search is an attempt to locate service events that have been recorded for the telematics unit 18 associated with that STID. The service event of interest is generally connectivity failure report(s) or record(s).

It is to be understood that a connectivity failure report is indicative of a failure to match an electronic serial number with a mobile number stored in the telematics unit 18.

If no connectivity failure report/record is found to be associated with the STID, an inference may be made that the subscriber's account and MIN/MDN is still active. If, however, a connectivity failure report/record is associated with the STID, an inference may be made that the subscriber is in, or has gone through a termination process, and that the MIN/MDN is deactivated (i.e., no longer corresponds with the telematics unit 18 ESN).

In the event that the latter inference is made, the call center 46 sets a signal that is indicative of the subscriber status change. In one embodiment, the call center 46 learns that the wireless service provider has deactivated the MIN/MDN for the particular telematics unit 18, and updates the subscriber's record accordingly (i.e., notes that the particular account is no longer active). In another embodiment, the call center 46 may note the subscriber record to review or check the account at a later date.

After making an inference that the telematics unit 18 of interest is no longer active, the call center 46 may contact the wireless service provider to inquire as to the status of the wireless service for the telematics unit 18. The call center 46 requests that the wireless service provider confirms whether the MIN/MDN located in the call center's database 52 is still associated with the ESN of the telematics unit 18. The wireless service provider can determine if the MIN/MDN is still active or if it has been deactivated for that particular ESN. The wireless service provider then provides such information to the call center 46, who can update (e.g., MIN and ESN no longer match and ownership has changed) or maintain their records (e.g., MIN and ESN match and ownership has not changed).

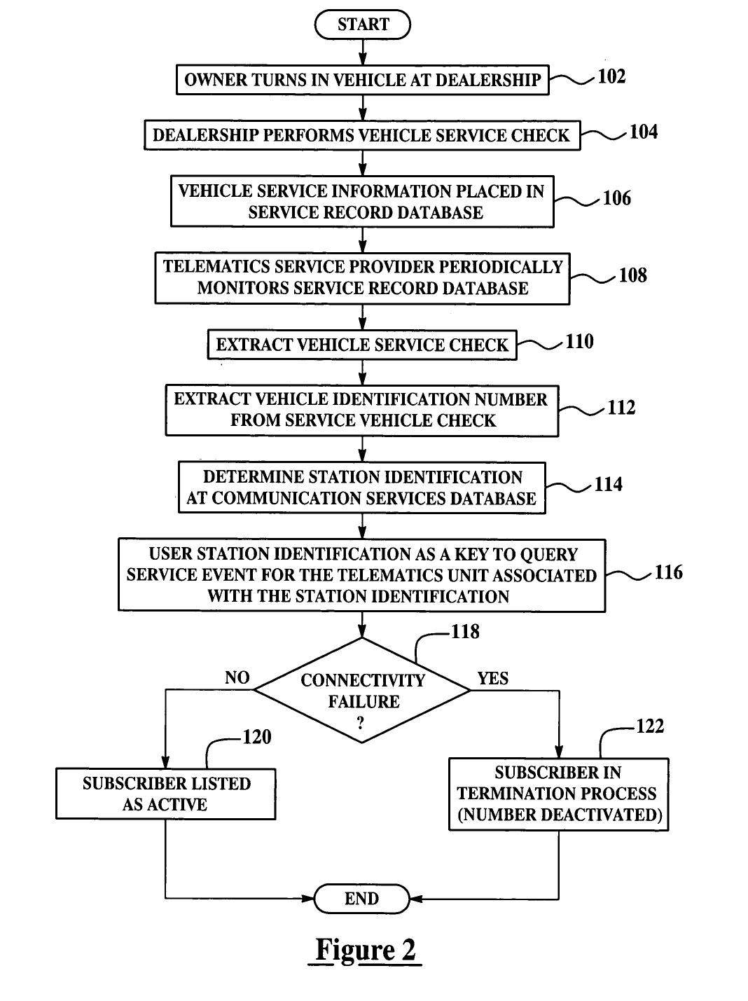

Referring now to FIG. 2, an embodiment of the method of tracking changes of subscribers for an in-vehicle telematics service includes an owner/user turning in the vehicle 12 at a dealership, as depicted at reference numeral 102; the dealership performing a vehicle service check, as depicted at reference numeral 104; and vehicle service information being placed in a service record database 60, as depicted at reference numeral 106. The telematics service provider 46 periodically monitors the service record database 60, as depicted at reference numeral 108; and extracts a vehicle service check, as depicted at reference numeral 110. In an embodiment, the telematics service provider 46 extracts a vehicle service check, for example, if it is determined that the vehicle service check is new to the service record database 60 since the last instance of periodic monitoring.

The method further includes extracting a vehicle identification number from the service vehicle check, as depicted at reference numeral 112; and determining a station identification (STID) at the communications services database 52 located at the telematics service provider 46, as depicted at reference numeral 114. The STID is used as a key to query a service event for the telematics unit 18 associated with the station identification (STID), as depicted at reference numeral 116. This embodiment of the method then includes determining whether the service event indicates a connectivity failure, as depicted at reference numeral 118. If no connectivity failure report is indicated, then the subscriber is listed as active, as depicted at reference numeral 120. If a connectivity failure report is indicated, then the subscriber may currently be in the service termination process, and the number (MIN/MDN) may be deactivated, as depicted at reference numeral 122. While not shown in FIG. 2, as previously described, the telematics service provider may update or maintain their subscriber records accordingly.

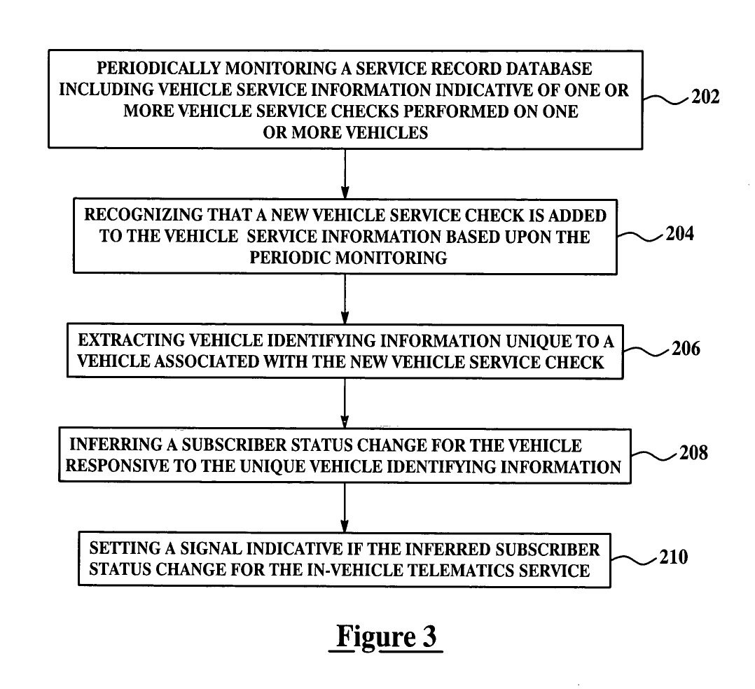

Referring now to FIG. 3, another embodiment of the method of tracking changes of subscribers for an in-vehicle telematics service includes periodically monitoring a service record database 60 including vehicle service information indicative of one or more vehicle service checks performed on one or more vehicles 12, as depicted at reference numeral 202. The method further includes recognizing that a new vehicle service check is added to the vehicle service information, based upon the periodic monitoring, as depicted at reference numeral 204; and extracting vehicle identifying information unique to a vehicle 12 associated with the new vehicle service check, as depicted at reference numeral 206. Yet further, the method includes inferring a subscriber status change for the vehicle 12 responsive to the unique vehicle identifying information, as depicted at reference numeral 208; and setting a signal indicative of the inferred subscriber status change for the in-vehicle telematics service, as depicted at reference numeral 210.

It is to be understood that inferring a subscriber status change may be accomplished as previously described in reference to FIG. 1.

Further, it is to be understood that the terms “connect/connects/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

While several embodiments have been described in detail, it will be apparent to those skilled in the art that the disclosed embodiments may be modified. Therefore, the foregoing description is to be considered exemplary rather than limiting.

1. A method of tracking changes of subscribers for an in-vehicle telematics service, the method comprising:
periodically monitoring a service record database including vehicle service information indicative of one or more vehicle service checks performed on one or more vehicles;
recognizing that a new vehicle service check is added to the vehicle service information based upon the periodic monitoring;
extracting vehicle identifying information unique to a vehicle associated with the new vehicle service check;
inferring a subscriber status change for the vehicle responsive to the extracted vehicle identifying information; and
setting a signal indicative of the inferred subscriber status change for the in-vehicle telematics service.

2. The method of claim 1 wherein the unique vehicle identifying information is a vehicle identification number, and wherein the method further includes determining if the vehicle identification number is associated with a station identification, wherein the station identification is indicative of the fact that the vehicle is equipped with an in-vehicle telematics unit.

3. The method of claim 2 wherein inferring a subscriber status change includes:
querying a subscriber database to determine if the station identification is associated with a connectivity failure report indicative of a failure to match an electronic serial number unique to the in-vehicle telematics unit with a mobile number stored in the in-vehicle telematics unit; and
if a connectivity failure report is included, updating the subscriber database to indicate that an account associated with the subscriber is no longer active.

4. The method of claim 3 wherein updating the subscriber database includes at least one of changing data associated with the subscriber, or marking the account for further review.

5. The method of claim 3 wherein the mobile number is selected from a mobile dialing number and a mobile information number.

6. The method of claim 3, further comprising:
retrieving the electronic serial number and the mobile number of the in-vehicle telematics unit from the subscriber database;
requesting a wireless carrier to determine whether the electronic serial number is associated with the mobile number; and
receiving notice of the failure to match from the wireless carrier.

7. The method of claim 1 wherein the periodic monitoring: is based on time zone; occurs about every twenty-four (24) hours; occurs during off-peak times; or combinations thereof.

8. A system for tracking changes of subscribers for an in-vehicle telematics service, the system comprising:
means for periodically monitoring a service record database including vehicle service information indicative of one or more vehicle service checks performed on one or more vehicles;
means for recognizing that a new vehicle service check is added to the vehicle service information based upon the periodic monitoring;
means for extracting vehicle identifying information unique to a vehicle associated with the new vehicle service check;
means for inferring a subscriber status change for the vehicle responsive to the extracted vehicle identifying information; and
means for setting a signal indicative of the inferred subscriber status change for the in-vehicle telematics service.

9. The system of claim 8 wherein the unique vehicle identifying information is a vehicle identification number, and wherein the system further includes means for determining if the vehicle identification number is associated with a station identification, wherein the station identification is indicative of the fact that the vehicle is equipped with an in-vehicle telematics unit.

10. The system of claim 9 wherein the means for inferring the subscriber status change includes:
means for querying a subscriber database to determine if the station identification is associated with a connectivity failure report indicative of a failure to match an electronic serial number unique to the in-vehicle telematics unit with a mobile number stored in the in-vehicle telematics unit; and
means for updating the subscriber database to indicate that an account associated with the subscriber is no longer active.

11. The system of claim 10 wherein the means for updating the subscriber database includes at least one of means for changing data associated with the subscriber, or means for marking the account for further review.

12. The system of claim 10 wherein the mobile number is selected from a mobile dialing number and a mobile information number.

13. The system of claim 10, further comprising:
means for retrieving the electronic serial number and the mobile number of the in-vehicle telematics unit from the subscriber database;
means for requesting a wireless carrier to determine whether the electronic serial number is associated with the mobile number; and
means for receiving notice of the failure to match from the wireless carrier.

14. The system of claim 8 wherein the means for periodically monitoring include a means for monitoring about every twenty-four (24) hours.

15. A system for tracking changes of subscribers for an in-vehicle telematics service, the system comprising:
a service record database including vehicle service information indicative of one or more vehicle service checks performed on one or more vehicles, the vehicle service check including unique vehicle identifying information;
a subscriber database including information for at least one telematics service subscriber; and
a telematics service provider in communication with both the service record database and the subscriber database, the telematics service provider configured to determine if the unique vehicle identifying information is associated with the at least one telematics service subscriber, and infer, from the determination, whether a subscriber status has changed.

16. The system of claim 15 wherein the unique vehicle identifying information is a vehicle identification number, wherein the information for the at least one telematics service subscriber includes a station identification, and wherein the vehicle identification number is associated with the station identification.

17. The system of claim 16 wherein the information for the at least one telematics service subscriber further includes a connectivity failure report indicative of a failure to match an electronic serial number unique to an in-vehicle telematics unit associated with the at least one telematics service subscriber with a mobile number stored in the in-vehicle telematics unit.

18. The system of claim 17 wherein the telematics service provider is further configured to update the subscriber database based on the connectivity failure report.

19. The system of claim 17 wherein the mobile number is selected from a mobile dialing number and a mobile information number.

20. The system of claim 17, further comprising a wireless carrier in communication with the telematics service provider, the wireless carrier capable of determining whether the electronic serial number is associated with the mobile number.
